(19) United States
(12) Patent Application Publication
(10) Pub. No.: US 2013/0346855 A1
(43) Pub. Date: Dec. 26, 2013

(54) PROVIDING DIFFERENTIATED DISPLAY OF A MAP FEATURE

(71) Applicants: Benjamin Charles Appleton, Summer Hill (AU); James Brian McGill, Forest Lodge (AU)

(72) Inventors: Benjamin Charles Appleton, Summer Hill (AU); James Brian McGill, Forest Lodge (AU)

(73) Assignee: GOOGLE INC., Mountain View, CA (US)

(21) Appl. No.: 13/531,447

(22) Filed: Jun. 22, 2012

(51) Int. Cl. G06F 17/00

(52) U.S. Cl. 715/273

(57) ABSTRACT

A system and method for providing differentiated display of a map feature is provided. Vector data which defines one or more features for a map is received from a server. The map is displayed based on the received vector data. A user selection of at least one feature from among the one or more features for differentiated display within the map is received. Differentiated display of the at least one feature is provided within the map, based on the vector data received from the server and on the received user selection.

### BACKGROUND

The present disclosure generally relates to digital maps, and, in particular, to providing differentiated display of a map feature.

Complex map layers may consist of billions of features, which can be difficult for a client device to hold in memory or render. Such layers are typically rendered as image tiles by a HTTP server. However, it may be desirable for a mapping application displaying layers (e.g., at a client device) to highlight particular features.

### SUMMARY

The disclosed subject matter relates to machine-implemented method of providing differentiated display of a map feature. The method includes receiving, from a server, vector data which defines one or more features for a map, and displaying the map based on the received vector data. The method further includes receiving a user selection of at least one feature from among the one or more features for differentiated display within the map, and providing for differentiated display of the at least one feature within the map, based on the vector data received from the server and on the received user selection.

The disclosed subject matter further relates to a system for providing differentiated display of a map feature. The system includes one or more processors, and a machine-readable medium comprising instructions stored therein, which when executed by the processors, cause the processors to perform operations including receiving, from a server, vector data which defines one or more features for a map, the vector data comprising at least one vector tile corresponding to the one or more features for the map. The operations further include displaying the map based on the received vector data, receiving a user selection of at least one feature from among the one or more features for differentiated display within the map, and providing for differentiated display of the at least one feature within the map, based on the vector data received from the server and on the received user selection.

The disclosed subject matter also relates to a machine-readable medium comprising instructions stored therein, which when executed by a system, cause the system to perform operations including receiving, from a server, vector data which defines one or more features for a map, the vector data comprising at least one vector tile corresponding to the one or more features for the map. The operations further include displaying the map based on the received vector data, receiving a user selection of at least one feature from among the one or more features for differentiated display within the map, and providing for differentiated display of the at least one feature within the map based on the vector data received from the server and on the received user selection, by modifying an attribute of the at least one feature within the at least one vector tile so as to differentiate the display of the at least one feature from the remaining one or more features within the map.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example distributed network environment which can provide differentiated display of a map feature.

FIGS. 2A-2B illustrate an example of a graphical user interface for providing differentiated display of a map feature.

FIG. 3 illustrates an example process by which differentiated display of a map feature is provided.

FIG. 4 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

As noted above, complex map layers may consist of billions of features, which can be difficult for a client device to hold in memory or render. Such layers are typically rendered as image tiles by a HTTP server. However, it may be desirable for a mapping application displaying layers (e.g., at a client device) to highlight particular features.

The disclosed subject matter provides for providing differentiated display of a selected map feature. Vector data which defines one or more features for a map is received from a server (e.g., from an HTTP server). The map is displayed based on the received vector data. A user selection of at least one feature is selected for differentiated display within the map. Differentiated display of the at least one feature is provided within the map, based on the vector data received from the server (e.g., the initial vector data) and on the received user selection.

The vector data can include at least one vector tile corresponding to the one or more features for the map. The providing for differentiated display can include modifying an attribute of the at least one feature within the at least one vector tile so as to differentiate the display of the at least one feature from other features within the map.

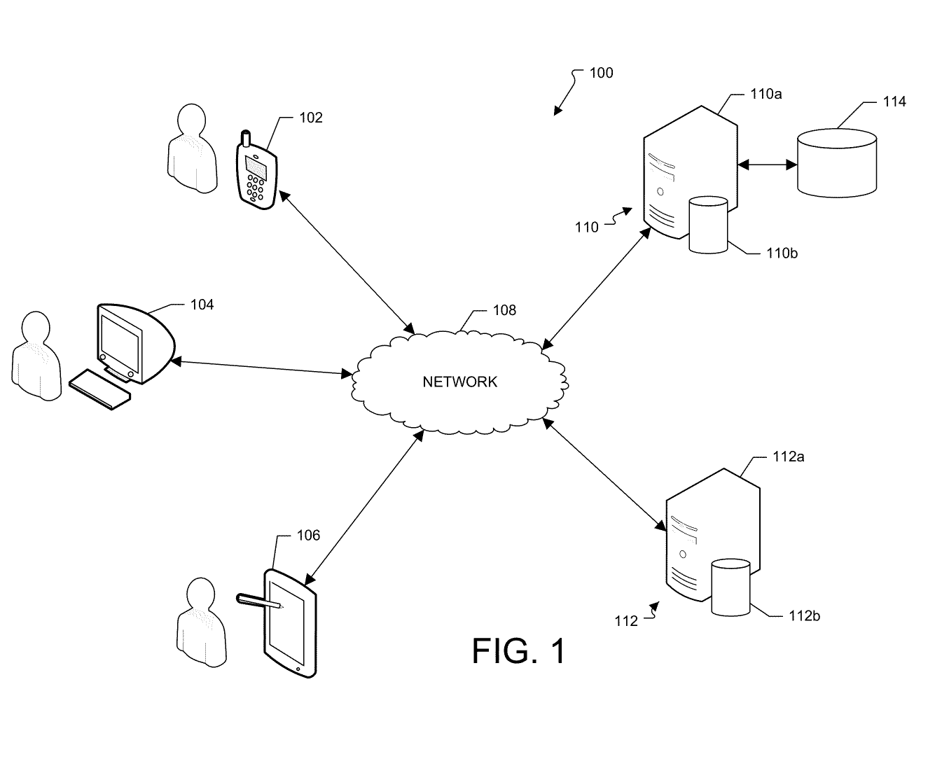

FIG. 1 illustrates an example distributed network environment which can provide differentiated display of a map feature. A network environment 100 includes computing devices 102, 104 and 106, and computing systems 110 and 112. Computing system 112 can access storage device 114, which corresponds to one or more databases. Computing devices 102-106, and computing systems 110-112 can communicate with each other through a network 108. Each of computing systems 110-112 can include one or more computing devices 110a-112a (e.g., one or more servers), respectively, and one or more computer-readable storage devices 110b-112b (e.g., one or more databases), respectively.

Each of computing devices 102-106 can represent various forms of processing devices. Example processing devices can include a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices. Computing devices 102-106 and 110a-112a may be provided access to or receive application software executed or stored on any of the other computing systems 102-106 and 110a-112a.

Each of computing devices 110a-112a may be any system or device having a processor, a memory, and communications capability for providing content to the electronic devices. In some example aspects, each of servers 110-112 can be a single computing device, for example, a computer server. In other embodiments, each of servers 110-112 can represent more than one computing device working together to perform the actions of a server computer (e.g., cloud computing). Further, each of computing devices 110a-112a can represent various forms of servers including, but not limited to a web server, an application server, a proxy server, a network server, or a server farm.

In some aspects, the computing devices may communicate wirelessly through a communication interface (not shown), which may include digital signal processing circuitry where necessary. The communication interface may provide for communications under various modes or protocols, for example, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, for example, using a Bluetooth, WiFi, or other such transceiver.

In some aspects, network environment 100 can be a distributed client/server system that spans one or more networks, for example, network 108. Network 108 can be a large computer network, for example, a local area network (LAN), wide area network (WAN), the Internet, a cellular network, or a combination thereof connecting any number of mobile clients, fixed clients, and servers. Further, the network 108 can include, but is not limited to, any one or more of the following network topologies, including a bus network, a star network, a ring network, a mesh network, a star-bus network, tree or hierarchical network, and the like. In some aspects, communication between each client (e.g., computing devices 102, 106) and server (e.g., servers 110-112) can occur via a virtual private network (VPN), Secure Shell (SSH) tunnel, or other secure network connection. In some aspects, network 108 may further include a corporate network (e.g., intranet) and one or more wireless access points.

In example aspects, processing device 110a executes computer instructions stored in data store 110b, for example, to host a mapping service. The mapping service may be implemented using any combination of markup language and scripting elements, e.g., using HTML and Javascript. The mapping service may be accessible via a graphical user interface (GUI) provided display for any of electronic devices 102-106. Such a GUI may include functions enabling the user of electronic device 102-106 to manipulate a position and orientation of a virtual camera in order to view portions of a geographic area corresponding to a digital map from different perspectives. The GUI may be presented as a map viewer (e.g., within a browser or other application on electronic device 102-106). In example aspects, such a mapping service displays a visual representation of a map, e.g., as a viewport for displaying a grid of rendered tiles.

In this regard, the mapping service hosted on server 110 accesses vector tiles (e.g., from storage device 114). In example aspects, the mapping service may retrieve bulk and/or individual vector tiles (e.g., from storage device 114). As used herein, a “vector tile” refers to vector data from which an image corresponding to a mapping tile can be rendered. Vector tiles describe geographic features (e.g., bodies of water, mountains, landmarks, buildings or other structures, etc.), such as data from a geographic information system (GIS). A vector tile includes vector data for points, lines or polygons, where the points, lines and polygons represent features of a map. In example aspects, a vector tile includes attributes for the features represented by the vector data. These attributes include, but are not limited to, color, size, style, associated text, highlighting and animation for the points, lines and polygons. In other example aspects, the attribute data is provided separate from the vector tiles themselves.

As the viewport within the GUI is moved (e.g., based on user input at electronic device 102-106), the mapping service (e.g., hosted on system 110) may request additional vector tiles (e.g., from storage device 114) as may be necessary, for example, when the requested vector tiles have not already been cached in a local memory of the user device. It should be noted that the server(s) which serve the vector tiles can be the same or different server(s) from the server(s) which serve other data (e.g., image data) to electronic device 102-106.

Furthermore, the GUI on electronic device 102-106 interfaces with computing system 110 in order to coordinate the operation of user interface elements for the mapping service. For example, the GUI and the mapping service may operate together so as to allow the user to interact with either GUI or the mapping service in order to change the user's virtual location or views displayed on the map as provided by the mapping service. Further, any detected user interaction may cause a change in location or orientation to be reflected in the visual representation of the map or satellite imagery corresponding to a particular geographic location as displayed in the GUI or in another content area provided by the mapping service or both. Furthermore, a user selection can be received for one feature from among multiple features within the displayed map. Electronic device 102-106 can provide for differentiated display of the selected feature within the map in response to the user selection.

It should be noted that in addition providing mapping directly to electronic device 102-106, the mapping service hosted on server 110 can also be invoked through a map search request performed at electronic device 102-106. Thus, in example aspects, processing device 112a executes computer instructions stored in data store 112b, for example, to host a map search service. The map search service hosted on server 112 receives a search query from electronic device 102-106 over network 108. The map search service processes the search query and, in response, provides one or more search results to electronic device 102-106. The search query can be for a map search system or a general search query that includes a term that the map search service, or another service, identifies as map related.

The map search service identifies a location for one or more of the search results. The location may include, for example, coordinates in a coordinate system, such as a latitude, a longitude, and a zoom level. Electronic device 102-106 receives the search results, processes the instructions in the search results, and sends a request to the mapping service hosted on server 110 via network 108. In response, the mapping service provides one or more vector tiles to electronic device 102-106 via network 108. Electronic device 102-106 receives the vector tiles from the mapping service, and uses the instructions from the search results to render the vector tiles to display a map.

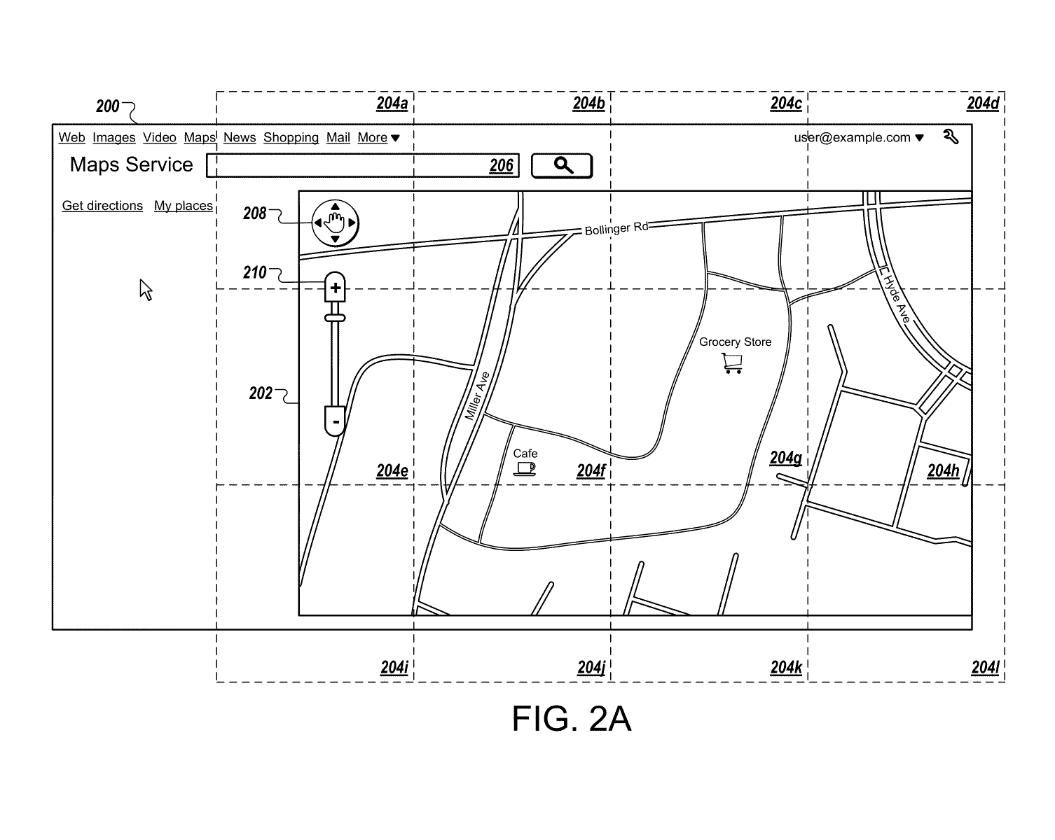

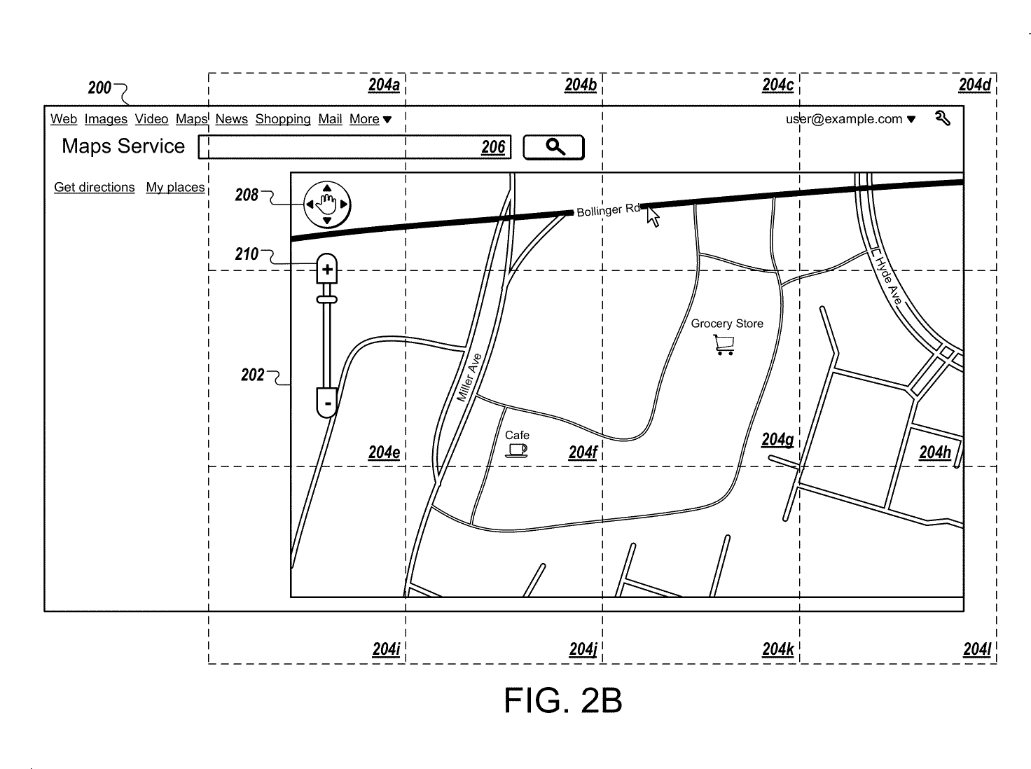

FIGS. 2A-2B illustrate an example of a graphical user interface for providing differentiated display of a map feature. FIG. 2A shows an example of a graphical user interface 200 for presenting rendered tiles. In the example of FIG. 2A, the graphical user interface 200 is a web page provided by a map search service (e.g., hosted on server 112). It should be noted that the subject disclosure is not limited to web pages provided by a map search service, and that other applications which relate to mapping can be used.

The graphical user interface 200 includes a map area 202. The map area 202 presents at least a portion of one or more rendered tiles 204a-1 (e.g., rendered from vector data) that make up a map. The map may include other tiles that are not currently presented within the map area 202, such as tiles to the left, right, up, down, or on different zoom level than the rendered tiles 204a-1. The dotted lines represent the full extent of each of the rendered tiles 204a-1, but only the portion of each of the rendered tiles 204a-1 that is within the map area 202 is presented to a user in the graphical user interface 200.

The graphical user interface 200 includes instructions from the map search service (e.g., hosted on server 112) for downloading the vector tiles from a mapping service (e.g., hosted on server 110). The vector tiles can be downloaded in bulk or individually. As noted above, a vector tile corresponds to vector data from which an image corresponding to a map tile can be rendered. A vector tile includes vector data for points, lines or polygons, where the points, lines and polygons represent features of a map. In addition, attributes for the vector tiles can be downloaded for the features represented by the vector tiles. The attributes can be part of each vector tile or separate (e.g., where attributes apply to multiple vector tiles). These attributes include, but are not limited to, color, size, style, associated text, highlighting and animation for the points, lines and polygons. Based on the vector tiles and attributes received from the mapping service, the electronic device (e.g., 102-106) can render the vector data to produce rendered tiles (e.g., 204a-1) corresponding to the map. In example aspects, vectors can be rendered using vector rendering engines including, but not limited to, Scalable Vector Graphics (SVG), Vector Markup Language (VML), Canvas 2D, or Web Graphics Library (WebGL).

The graphical user interface 200 instructions may include information related to the vector tile, such as information that identifies a zoom level of the vector tile and a position of the vector tile within the zoom level (e.g., in an x-y coordinate space). Regarding zoom level, it should be noted that the amount of data provided for a vector tile may vary based on the zoom level. For example, the vector tiles for “Bollinger Rd” in FIG. 2A received from the mapping service (e.g., hosted on server 110) may have a lower level of detail (e.g., less detail in terms of vector points, lines, polygons or attributes corresponding to the road shape) in a low zoom level, and may have a higher level of detail in a high zoom level. In a further example, when the zoom level is very low (e.g., zoomed out at a state or country level), certain features (e.g., a road such as “Bollinger Rd”) may be omitted entirely from vector tiles. Thus, the thinning of features is provided for, so that the mapping service (e.g., hosted on server 110) does not send millions of features for zoomed out tiles.

The graphical user interface 200 instructions can include an identifier for a type of tile (also referred to as a layer) to be downloaded, such as a street map tile, a topographical map tile, or a road overlay map tile. For example, the electronic device (e.g., 102-106) can send a request for vector tiles that includes a “bike” identifier. The “bike” identifier indicates that the electronic device (e.g., 102-106) has requested that the mapping service (e.g., hosted on server 110) provide a street map tile and a bike path tile. These tiles are received as vector tiles at the electronic device and rendered at the electronic device for display as map tiles. In another example, the electronic device (e.g., 102-106) can send a request for vector tiles that includes a “t@127” identifier. The “t@127” indicates that the electronic device (e.g., 102-106) has requested that the mapping service (e.g., hosted on server 110) provide a terrain or topological tile together with a road overlay tile.

The map search service (e.g., hosted on server 112) and/or the mapping service (e.g., hosted on server 110) can provide instructions to the electronic device (e.g., 102-106) to overlay at least one tile on top of another tile. The electronic device (e.g., 102-106) then receives the overlay tile and the other tile, and uses the instructions to present the overlay tile on top of the other tile. The electronic device (e.g., 102-106) then presents the combination of the overlay tile and the other tile in the graphical user interface 200 as one of the rendered tiles 204a-1. In rendering the vector data, transparencies can be included in the graphics so as to have one layer show through another layer, or to reduce overlap of displayed layers. The transparency data can be provided (e.g., from the mapping service) within the vector tiles or separate from the vector tiles.

With further reference to multiple layers, an advantage of client-side rendering is that when a backend request fails to respond, a failure signal can be sent to the front-end client. For example, an application (e.g., a browser at electronic device 102-106) can fetch a single tile from layers A and B in a single HTTP request. The backend (e.g., the mapping service hosted on server 110) for layer B fails to respond, and the frontend application sends the data for layer A and a failure for layer B in its response. The application displays layer A immediately, then retries layer B at a later time.

The graphical user interface 200 includes controls that allow a user to interact with the map area 202. For example, the graphical user interface 200 may include a search control 206 that can receive a search query input from a user, such as the search query “Sunnydale, Calif.” The graphical user interface 200 provides the search query to the map search service (e.g., hosted on server 112). The map search service (e.g., hosted on server 112) determines that the search query includes a city of “Sunnydale” and a state of “CA” or “California.”

In example aspects, the map search service (e.g., hosted on server 112) and/or the mapping service (e.g., hosted on server 110) identify the vector tiles around the identified location and provide information regarding the identified vector tiles (e.g., in the form of tile identifiers) to the electronic device (e.g., 102-106). The electronic device (e.g., 102-106) then sends one or more requests to the mapping service (e.g., hosted on server 110) for the corresponding vector tiles.

The graphical user interface 200 also includes a pan control 208 and a zoom level control 210. A user can make an input using the pan control 208 or another type of input, such as with arrow keys on a keyboard/touchscreen or by clicking and dragging the map area 202 with a pointing device, to pan to the map area 202 to the left, right, up, or down. A user can make an input using the zoom level control 210 or another type of input, such as by double clicking on the map area 202 with a pointing device, to zoom to another zoom level in the map area 202. The graphical user interface 200 includes instructions that receive the inputs and pans or zooms the map area 202 to a new position or zoom level within the map. In response, the graphical user interface 200 sends a request to the mapping service (e.g., hosted on server 110) for additional tiles that are located at the new position and/or zoom level.

FIG. 2B shows an example of the graphical user interface 200 in which differentiated display of a map feature is provided. In particular, a user can select a feature (e.g., a road, a place, a city, a state or any other type of geographical feature) among multiple features for differentiated display within the map.

In the example of FIG. 2B, a user selects the road “Bollinger Rd” for differentiated display by hovering over the feature in the map area 202. Thus, the hover event (e.g., a mouseover event or a corresponding event on a touchscreen) triggers graphical user interface 200 to perform differentiated display of the selected feature. Stated otherwise, on a mouseover event, an event can be effected on the layer with the feature ID, where the feature ID corresponds to the selected feature(s). The graphical user interface 200 (e.g., via a listener) intercepts this event, and sets differentiated display (e.g., highlighting, an animation loop) which repeatedly sets the style of that feature in that layer. It should be noted that user selection of a feature for differentiated display is not limited to hovering over a feature, and can be performed by other user input (e.g., a click or touch event, a menu driven interface, text input).

Features can selected by attribute (metadata for that feature), by class (explicitly assigned by a backend), or per feature. In this regard, user selection is not limited to one feature, and multiple features can be selected for differentiated display. For example, user selection can be performed via manual selection of multiple features by the user (e.g., multiple user selections via click or touch events). In another example, for class selection, classes can be assigned by a layer backend so that the client can select/restyle groups of features. Developers may change the style for a class or feature at any time.

In yet another example, the selection of multiple features can be effected via an interface (not shown) for selecting a particular feature attribute. Thus, it is possible to filter (or remove) features by query. As noted above, these attributes can be provided by the vector data for vector tiles received from the mapping service (e.g., hosted on server 110). After the user specifies the one or more attributes, the graphical interface 200 can provide for differentiating display of all features within the displayed map area 202 with matching attributes. For example, user selection can be based on an attribute test, such as “WHERE Age >21”. In this regard, either the client (e.g., electronic device 102-106) may know the attribute value (e.g., Age) for each feature (e.g., corresponding to a local and immediate update), or the backend (e.g., the mapping service hosted on server 110) can evaluate the test and classify each feature in the response (e.g., corresponding to a server round-trip).

After user selection of a feature(s), the graphical user interface 200 can include instructions for differentiating the display of the selected feature. The differentiated display can correspond to modifying an attribute of the feature so as to differentiate the display of the feature from the remaining features within the map. The differentiated display can be provided by repainting vector data corresponding to the feature, and refraining from repainting vector data which does not correspond to the feature.

In addition, a sidebar interface can be provided to assist in distinguishing selected features. For example, a list of all features can be built in the current viewport, and a dynamic sidebar can be maintained. The sidebar is linked to the map, so that hovering on one highlights the corresponding feature on the other.

In example aspects, the duration of the differentiated display can be based on the duration of the user selection. For example, if user selection is based on a hover event, the differentiated display can be limited to the amount of time that the user hovers over the feature. In other example aspects, the duration of the differentiated display can be triggered by a first user input (e.g., via a click or touch event, menu selection or text input to differentiate display) and continues until a second user input (e.g., another click or touch event, menu selection or text input to stop differentiating display).

In the example of FIG. 2B, the selected “Bollinger Rd” feature is highlighted relative to the other features within the map area 202. In another example, if the displayed map is the United States, a state (e.g., California) may include offshore islands. When a user selects the state, both the mainland and offshore islands can be highlighted, to more clearly indicate that the offshore islands are part of the state. However, the differentiating display of the selected feature is not limited to highlighting. Other examples of differentiating display include, but are not limited to changing color, size, style and/or associated text of the feature within the map area 202.

The differentiated display can also be provided by animating the feature within the map area 202. For example, a marker (e.g., a pin, not shown) corresponding to the feature can bounce within the displayed map so as to differentiate display of the selected feature. When a user touches a description of a feature in a sidebar (not shown), the associated marker can bounce up and down, to more clearly indicate that the bouncing marker is the differentiated feature.

Several considerations can be taken into account when repainting features within the map. In this regard, the display of tile boundaries can be avoided (or reduced) during a large repaint. For example, some actions, such as restyling every feature on the map, may require repainting many features. In some browsers, tiles may become apparent during such a repaint. To avoid this, the application (e.g., graphical user interface 200) can repaint all tiles synchronously in a single operation.

In addition, the unnecessary repainting of tiles can be avoided. For example, some actions, such as changing the style of one feature, may affect few or none of the tiles on screen. For example, a feature may be offscreen when its style is changed. To facilitate this, each tile can expose the set of feature IDs (corresponding to the selected features) and class/style IDs (corresponding to a selected class/style) for all features in that tile. These sets can be consulted in order to avoid repainting tiles that are not affected by a change.

Furthermore, a repaint can be limited to a small region when a small feature changes. For example, some actions, such as repainting a marker during a bounce animation frame, only requires repainting a small region. To facilitate this, within each tile each feature can store the bounding rectangle for the portion of that feature that lies within the tile. When repainting individual features, these bounding rectangles can be consulted. If they are small enough, only that portion of the tile is repainted. This allows even slow browsers (or other applications) to support smooth animations such as bouncing markers.

As noted above, features can be removed by thinning (e.g., when the user zooms out) or by filtering (e.g., based on user selection of attributes). For example, the scenario can be considered where a layer contains 1 million features. Zoomed-out tiles require server-side thinning, where the server cannot send all features for the world tile, so the server thins down to 0.1% of features. A developer applies a filter (such as Age <1) which matches only 1% of features. The user will expect to see matching markers, but will almost certainly see 0 markers. To address this, it is possible to immediately restyle the features known to the browser (or other application). This may temporarily result in too little data being displayed. In addition, it is possible to re-fetch tiles from the server including the new filter. The developer can also be alerted to the fact that features have been thinned.

In example aspects, inconsistent thinning across tile boundaries can be problematic for the backend server(s). For example, if two neighboring tiles with different densities both require thinning, features which straddle the tile boundary may be thinned by one tile server (e.g., mapping service) but not by the neighboring tile's server (e.g., mapping service). This can be avoided or reduced by performing a double fetch operation. For example, the browser first sends its viewport and zoom level to the backend (e.g., mapping service hosted by server 110), which returns a “thinning cookie” to the browser. The backend can consult an in-memory histogram to obtain a quick estimate of the feature density d_viewport within the viewport. For a target density d_target, a sampling factor can be computed as s=d_target/d_viewport. The value s can be rounded to the nearest 2̂n, to improve cache hit rates, and n to can be encrypted avoid leaking the histogram. The resulting “thinning cookie” can be returned to the browser. Once the browser receives the thinning cookie, it requests each tile in view, simply appending the thinning cookie to each tile request. When a request hits a tile server, the server extracts the thinning cookie (optionally decrypting), and computes the sampling rate s, and deterministically samples the features in view by the sampling rate s, such as by comparing each feature's ID to the sampling parameter s. Although each tile request may hit a different tile server, each tile server thins deterministically from the same information, such that thinning agrees across tile boundaries.

Accordingly, the subject disclosure provides for differentiating display of map features using vector data. The differentiated display is provided without the need for a client (e.g., electronic device 102-106) to repeatedly access a mapping service (e.g., hosted on server 110). Rather, based on an initial set of vector data received the mapping service (e.g., hosted on server 110), the client itself (e.g., electronic device 102-106) can provide for differentiated display of selected map feature(s).

In general, the use of vector data for mapping tiles can provide advantages over use of image tiles. In this regard, vectors can be faster than image tiles. Vectors are typically much more compact than images, so they require low bandwidth. In addition, images can require one HTTP request per tile, whereas vectors can be bundled into a single HTTP request. It should be noted that bundling trades HTTP request minimization against caching. Also, vectors are typically faster to render in hardware than images, some applications (e.g., browsers) moving to hardware rendering can see an advantage in using vectors. In addition, vectors can have an improved cache hit rate, since vectors can separate styling from geometry. Further, the appearance of vectors can be modified without an additional HTTP fetch.

The appearance of vectors can also be advantageous compared to image tiles. Vectors can be styled in the browser, and can support dynamic effects such as hover. Also, vectors can rescale smoothly during a continuous zoom.

Vectors can also be seen as a better API when compared to image tiles. Using vectors allows mapping application developers to expose programmatic access to features and allows the features to be restyled, hidden and/or removed. In example aspects, vector tiles can include a per-tile status, which image tiles cannot. This allows for reloading just the tiles which fail to respond in time (e.g., for only the layers which fail to respond in time). With image tiles, the only solution is to reload all layers within the tile.

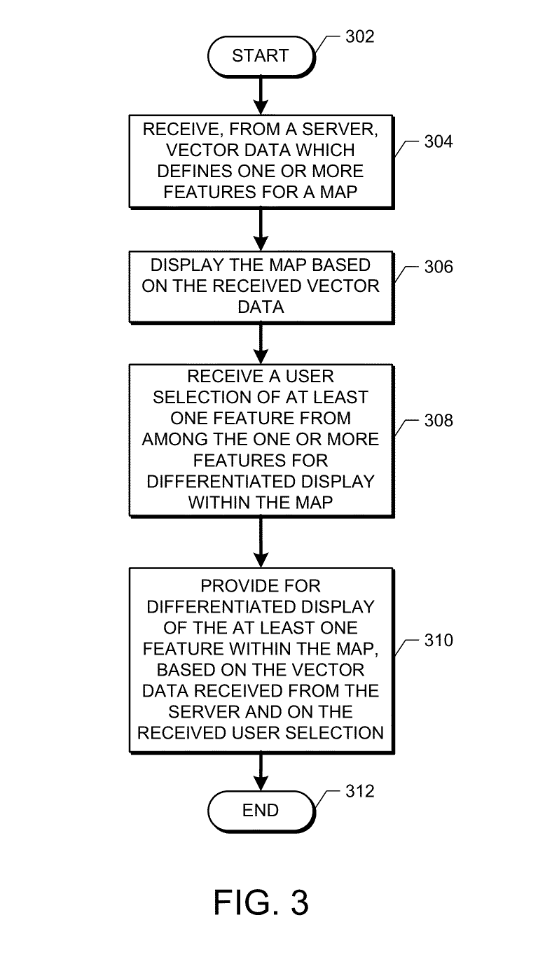

FIG. 3 illustrates an example process by which differentiated display of a map feature is provided. Following start block 302, vector data which defines one or more features for a map is received from a server at step 304. The vector data can include at least one vector tile corresponding to the one or more features for the map. At step 306, the map is displayed based on the received vector data.

At step 308, a user selection is received. The user selection is of at least one feature from among the one or more features for differentiated display within the map. The receiving the user selection can correspond to a hover event associated with the at least one feature. The receiving the user selection of the at least one feature can include receiving user input corresponding to a required feature attribute, where the at least one feature has the required feature attribute.

At step 310, differentiated display of the at least one feature within the map is provided, based on the vector data received from the server (e.g., the initial vector data) and on the received user selection. The differentiated display can be provided by modifying an attribute of the at least one feature within the at least one vector tile so as to differentiate the display of the at least one feature from the remaining one or more features within the map.

The differentiated display can be provided by changing at least one of a color, size or style of the at least one feature within the map so as to be different than that of the remaining one or more features. The differentiated display can also be provided by changing text associated with the at least one feature within the map so as to be different than that of the remaining one or more features.

In addition, the differentiated display can be provided by highlighting the at least one feature within the map so as to be different than the remaining one or more features. The differentiated display can also be provided by animating the at least one feature within the map so as to be different than the remaining one or more features. The animating the feature can include providing for a marker corresponding to the at least one feature to bounce within the map.

The differentiated display can be provided by repainting vector data which corresponds to the at least one feature, and refraining from repainting vector data which does not correspond to the at least one feature.

The receiving the vector data, the displaying the map, the receiving the user selection and the providing for differentiated display can be performed by an electronic device. A user indication to stop providing for differentiated display of the at least one feature within the map can be received, and the differentiated display of the at least one feature within the map can be stopped based on the received user indication and the received vector data. The process then ends at end block 312.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

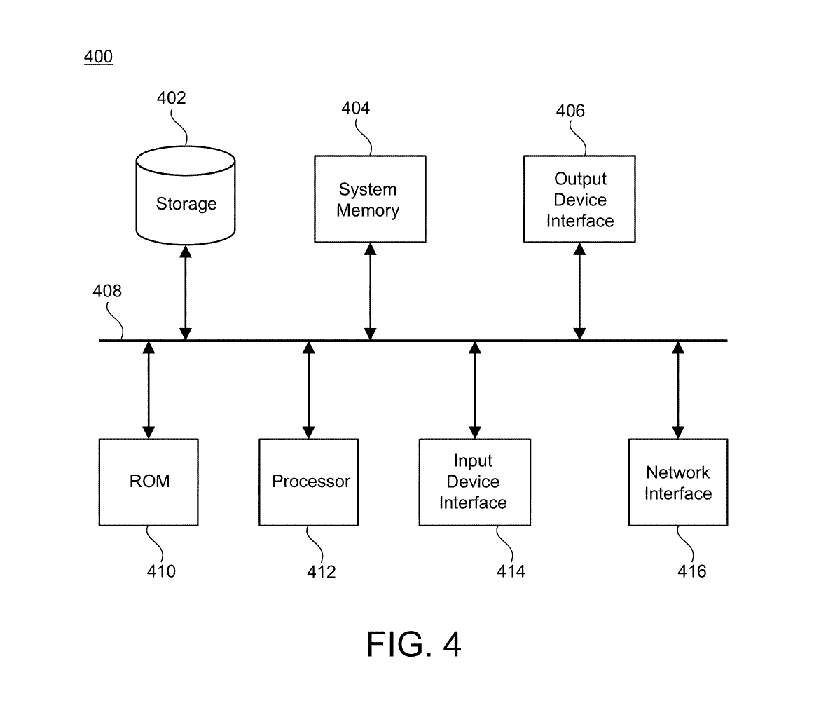

FIG. 4 conceptually illustrates an electronic system with which some implementations of the subject technology are implemented. Electronic system 400 can be a computer, phone, PDA, or any other sort of electronic device. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. For example, the various memory units include instructions for providing differentiated display of a map feature in accordance with some implementations. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A machine-implemented method of providing differentiated display of a map feature, the method comprising:
receiving, from a server, vector data which defines one or more features for a map;
displaying the map based on the received vector data;
receiving a user selection of at least one feature from among the one or more features for differentiated display within the map; and
providing for differentiated display of the at least one feature within the map, based on the vector data received from the server and on the received user selection.

2. The method of claim 1, wherein the vector data comprises at least one vector tile corresponding to the one or more features for the map.

3. The method of claim 2, wherein the providing for differentiated display comprises modifying an attribute of the at least one feature within the at least one vector tile so as to differentiate the display of the at least one feature from the remaining one or more features within the map.

4. The method of claim 1, wherein the providing for differentiated display comprises changing at least one of a color, size or style of the at least one feature within the map so as to be different than that of the remaining one or more features.

5. The method of claim 1, wherein the providing for differentiated display comprises changing text associated with the at least one feature within the map so as to be different than that of the remaining one or more features.

6. The method of claim 1, wherein the providing for differentiated display comprises highlighting the at least one feature within the map so as to be different than the remaining one or more features.

7. The method of claim 1, wherein the providing for differentiated display comprises animating the at least one feature within the map so as to be different than the remaining one or more features.

8. The method of claim 7, wherein the animating the feature comprises providing for a marker corresponding to the at least one feature to bounce within the map.

9. The method of claim 1, wherein the providing for differentiated display comprises:
repainting vector data which corresponds to the at least one feature; and
refraining from repainting vector data which does not correspond to the at least one feature.

10. The method of claim 1, wherein the receiving the user selection of the at least one feature comprises receiving user input corresponding to a hover event associated with the at least one feature.

11. The method of claim 1, wherein the receiving the user selection of the at least one feature comprises receiving user input corresponding to a required feature attribute, and wherein the at least one feature has the required feature attribute.

12. The method of claim 1, further comprising:
receiving a user indication to stop providing for differentiated display of the at least one feature within the map; and
providing for stopping the differentiated display of the at least one feature within the map, based on the received user indication and the received vector data.

13. The method of claim 1, wherein the receiving the vector data, the displaying the map, the receiving the user selection and the providing for differentiated display are performed by an electronic device.

14. A system for providing differentiated display of a map feature, the system comprising:
one or more processors; and
a machine-readable medium comprising instructions stored therein, which when executed by the processors, cause the processors to perform operations comprising:
receiving, from a server, vector data which defines one or more features for a map, the vector data comprising at least one vector tile corresponding to the one or more features for the map;
displaying the map based on the received vector data;
receiving a user selection of at least one feature from among the one or more features for differentiated display within the map; and
providing for differentiated display of the at least one feature within the map, based on the vector data received from the server and on the received user selection.

15. The system of claim 14, wherein the providing for differentiated display comprises modifying an attribute of the at least one feature within the at least one vector tile so as to differentiate the display of the at least one feature from the remaining one or more features within the map.

16. The system of claim 14, wherein the providing for differentiated display comprises changing at least one of a color, size or style of the at least one feature within the map so as to be different than that of the remaining one or more features.

17. The system of claim 14, wherein the providing for differentiated display comprises changing text associated with the at least one feature within the map so as to be different than that of the remaining one or more features.

18. The system of claim 14, wherein the providing for differentiated display comprises highlighting the at least one feature within the map so as to be different than the remaining one or more features.

19. The system of claim 14, wherein the providing for differentiated display comprises animating the at least one feature within the map so as to be different than the remaining one or more features.

20. A machine-readable medium comprising instructions stored therein, which when executed by a system, cause the system to perform operations comprising:
receiving, from a server, vector data which defines one or more features for a map, the vector data comprising at least one vector tile corresponding to the one or more features for the map;
displaying the map based on the received vector data;
receiving a user selection of at least one feature from among the one or more features for differentiated display within the map; and
providing for differentiated display of the at least one feature within the map based on the vector data received from the server and on the received user selection, by modifying an attribute of the at least one feature within the at least one vector tile so as to differentiate the display of the at least one feature from the remaining one or more features within the map.
